(19) United States
(12) Patent Application Publication
(10) Pub. No.: US 2012/0218315 A1
(43) Pub. Date: Aug. 30, 2012

(54) DISPLAY BACKLIGHT STRUCTURE CAPABLE OF ENHANCING COLOR SATURATION DEGREE AND BRILLIANCE AND WHITE BALANCE

(75) Inventors: KUAN-CHENG HSIAO, NEW TAIPEI CITY (TW); WEI-CHUNG LIN, NEW TAIPEI CITY (TW)

(73) Assignee: UNITY OPTO TECHNOLOGY CO., LTD., NEW TAIPEI CITY (TW)

(21) Appl. No.: 13/082,580

(22) Filed: Apr. 8, 2011

(30) Foreign Application Priority Data
Feb. 25, 2011 (TW) 100203450

(51) Int. Cl. G09G 5/10

(52) U.S. Cl. 345/690; 345/102

(57) ABSTRACT

A display backlight structure capable of enhancing color saturation degree and brilliance and white balance is provided and disposed in a backlight module to provide light source for a liquid crystal display module, comprising: a plurality of light emitting areas adjoined to each other and respectively comprising: a color light source unit having a red light LED, a green light LED and a blue light LED; and a luminance light source unit having a white light LED; and a controller electrically connected to the color light source unit and the luminance light source unit to regulate turning-on/off or gradation of the color light source unit and the luminance light source unit. Accordingly, the structure could have both high saturation degree and high light emitting efficiency to improve the optical performance of the display.

### CROSS-REFERENCE TO RELATED APPLICATIONS

This non-provisional application claims priority under 35 U.S.C. §119(a) on Patent Application No(s). 100203450 filed in Taiwan, R.O.C. on Feb. 25, 2011, the entire contents of which are hereby incorporated by reference.

### BACKGROUND OF THE INVENTION

1. Field of the Invention

The present invention relates to a backlight source structure of a display, and more particularly to a display backlight structure capable of enhancing color saturation degree and brilliance and white balance.

2. Description of the Related Art

A position of a CRT (cathode ray tube) has been replaced with a FPD (flat display device) to form a mainstream of display technology since A.D. 2000. The liquid crystal display (LCD) takes most portion in the FPD market. The LCD is mainly composed of a liquid crystal panel and a backlight module. The backlight module provides white light source, and the liquid crystal panel handles the color variation displayed by the display device. The structure of the liquid crystal display is that two glass substrates clamp a layer of liquid crystals, and the liquid crystal panel can be taken as an array composed of millions of pixel structures. Each pixel structure has TFT (thin film transistor) embedded on a lower glass of the liquid crystal panel while the glass substrate at an upper layer is pasted to a color filter. When current passes through the TFT to generate the electric field variation, liquid crystal molecules deflect to change the deflection polarity of light beam, and a polarization sheet is utilized to control whether or not light beam passes through, thereby deciding the light and shade of pixels. In addition, the upper glass is pasted to the color filter to form each pixel containing RGB colors. These pixels generating RGB colors form an image displayed on the panel. Since the liquid crystal panel could only guide light beam and may not generate light, the optical performance shown by the liquid crystal display device is restricted by the light source character provided from the backlight module. Consequently, improvement of the liquid crystal display device plays an important role for increasing the performance of the backlight module.

A conventional backlight module is composed of a backlight source, an optical module and a casing. Light generated by the backlight source passes through a light guide plate, a diffusion plate, a prism, a reflective sheet and group thereof in the optical module to generate phenomenon, such as reflection, refraction and scatter, thereby forming uniform planar light source. Finally, the planar light source exits from a light exit surface of the optical module. The performance of the backlight module can be detected upon standard items, such as luminance, color saturation degree, power consumption and size thickness. These items are close to the backlight source. Therefore, the adoption and design of the backlight source can be taken as a core of the backlight module. Its light source type mainly comprises a FL (fluorescent lamp tube), a CCFL (Cold Cathode Fluorescent Lamp) and a LED (light emitting diode). Since the light emitting power of the LED is rapidly increased in recent years, it becomes a major backlight source that directly uses a white light LED or performs color mixing from red, green and blue LEDs to obtain white light. Generally, white light LEDs can provide higher light emitting power. However, its color saturation degree is much lower than color mixing of RGB LEDs. Although the color mixing of RGB LEDs has the advantage of high color saturation degree, its luminance is relatively low. Both backlight sources mentioned above may not satisfy luminance and color saturation degree at same time.

To overcome the foregoing drawbacks to further improve the performance of the liquid crystal display device, the invention provides an improved backlight module for mixing white light with RGB LEDs to allow the invention to simultaneously have both rich color saturation and high luminance.

### SUMMARY OF THE INVENTION

In view of the shortcomings of the prior art, the inventor(s) of the present invention based on years of experience in the related industry to conduct extensive researches and experiments, and finally developed a display backlight structure capable of enhancing color saturation degree and brilliance and white balance as a principle objective so that the invention utilizes a conventional RGB color mixing technique to combine with a white light LED having high light emitting efficiency. Accordingly, both advantages are captured to form a light source structure having higher standard to improve the image quality displayed by a display device.

To achieve the foregoing objective, the display backlight structure capable of enhancing color saturation degree and brilliance and white balance is disposed in a backlight module to provide light source for a liquid crystal display module, the display backlight structure comprising: a plurality of light emitting areas adjoined to each other and respectively comprising: a color light source unit having a red light LED, a green light LED and a blue light LED; and a luminance light source unit having a white light LED; and a controller electrically connected to the color light source unit and the luminance light source unit to regulate turning-on/off or gradation of the color light source unit and the luminance light source unit.

In an embodiment, the color light source unit and the luminance light source unit are disposed to form at least a 1*4 single bar structure, which is irregularly disposed, having the red light LED, the green light LED, the blue light LED and the white light LED to allow the light emitting areas are adjoined to each other to form at least one light bar. Regarding to a demand of a display, the light bars are horizontally disposed in the backlight module. Accordingly, the light bars are vertically disposed in the backlight module. The light bars are also arranged and spaced in parallel relative to a horizontal direction of the liquid crystal display module in the backlight module. Alternatively, the light bars are also arranged and spaced in parallel relative to a vertical direction of the liquid crystal display module in the backlight module.

In an embodiment, the color light source unit and the luminance light source unit are disposed to form a 2*2 array structure, which is irregularly disposed, having the red light LED, the green light LED, the blue light LED and the white light LED to allow the light emitting areas adjoined to each other, thereby forming a matrix structure corresponding to a size of the backlight module. To increase the luminance, each light emitting area further comprises a reinforced light source unit disposed in a central position of the 2*2 array structure, wherein the reinforced light source unit has a green light LED or a white light LED.

The invention combines two white light LED backlight source structures of the conventional RGB light mixing source and the white light LED source and utilizes optical features to allow the invention to have both advantages of high color saturation degree as well as the RGB LED and high luminance of the white light LED to allow the backlight structure to have higher efficiency, thereby satisfying the trend of developing a display with high resolution and large size.

### BRIEF DESCRIPTION OF THE DRAWINGS

FIG. 1 is a schematic diagram of an installation (I) according to a preferred embodiment of the present invention;

FIG. 2 is a schematic diagram of a structure according to a preferred embodiment of the present invention;

FIG. 3 is a schematic diagram of an installation (II) according to a preferred embodiment of the present invention;

FIG. 4 is a schematic diagram of an assembly according to a preferred embodiment of the present invention;

FIG. 5 is a schematic diagram of an assembly according to another preferable embodiment of the present invention;

FIG. 6 is a schematic diagram of reinforcement according to another preferable embodiment of the present invention; and

FIG. 7 is a spectrum distribution diagram according to another preferable embodiment of the present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

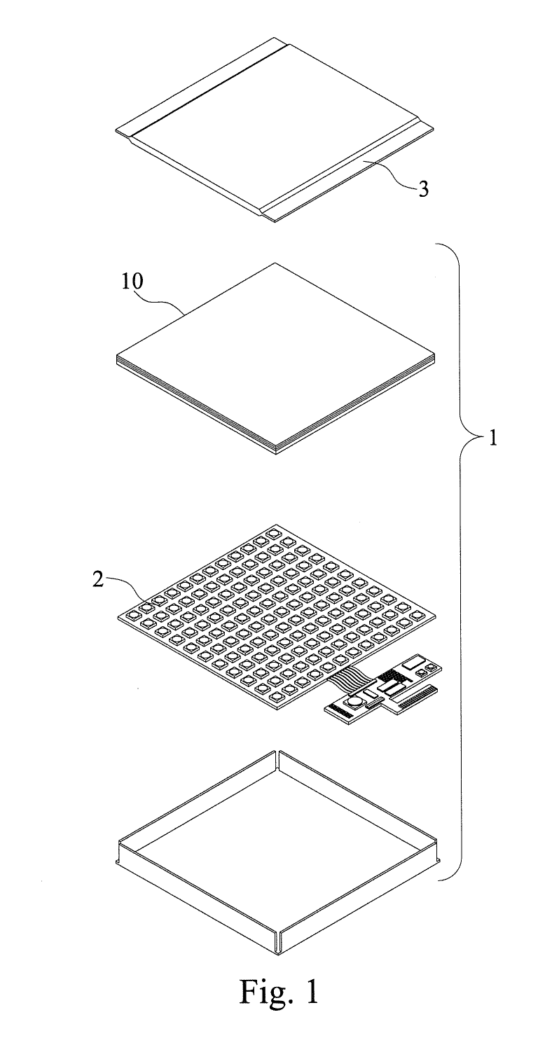

With reference to FIG. 1 for a schematic diagram (I) of an installation in accordance with a preferred embodiment of the invention is depicted. A display backlight structure 2 capable of enhancing color saturation degree and brilliance and white balance. The display backlight structure 2 capable of enhancing color saturation degree and brilliance and white balance is disposed in a backlight module 1, and converted by the backlight module 1 into uniform white light with plane that is used for providing a liquid crystal display module 3 so as to form a color frame displayed by a display.

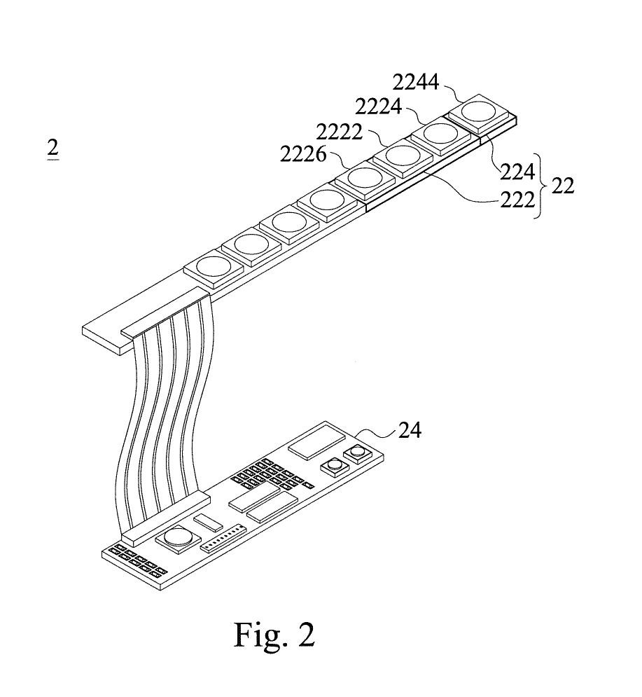

With reference to FIG. 2 for a schematic diagram of a structure in accordance with a preferred embodiment of the invention is depicted. The display backlight structure 2 capable of enhancing color saturation degree and brilliance and white balance comprises a plurality of light emitting areas 22. The light emitting areas 22 are basic units of mixing white light and adjoined to each other to form a light emitting source for the display backlight structure 2 capable of enhancing color saturation degree and brilliance and white balance. The light emitting areas 22 respectively comprise a color light source unit 222 with rich color saturation and a luminance light source unit 224 with high luminance. The color light source unit 222 has a red light LED 2222, a green light LED 2224 and a blue light LED 2226, wherein their advantages in optics can be obtained on CIE 1931 color space. According to current technology, the color gamut of the color light source unit 222 could satisfy the RGB (red-green-blue) standard frequently used by electronic products or provide the wide color gamut of above NTSC 100%. A desire color gamut range can be combined through different wavelengths of selected LEDs. However, since materials of LEDs producing colors are different, voltage property is different as well such that the color light source unit 222 regulating white balance is difficult and has higher cost. The luminance light source unit 224 has a white light LED 2244. The white light LED 2244 is selected with the blue light LED emitting yellow fluorescent powder. Since its luminescence efficiency is high, it can provide greater luminance. However, since its white light is composed of mixing yellow light with blue light having two wave bands, it lacks for red waveband spectrum to cause worse color rendition.

The display backlight structure 2 capable of enhancing color saturation degree and brilliance and white balance controls the color light source unit 222 and the luminance light source unit 224 that are turned on/off or gradated through a controller 24 electrically connected the color light source unit 222 and the luminance light source unit 224 and allows the color light source unit 222 and the luminance light source unit 224 to form a 1*4 single bar structure having the red light LED 2222, the green light LED 2224, the blue light LED 2226 and the white light LED 2244, which are irregularly arranged, through the light emitting areas 22 combined with the color light source unit 222 and the luminance light source unit 224 such that the light emitting areas 22 are adjoined to each other to form at least one light bar 26.

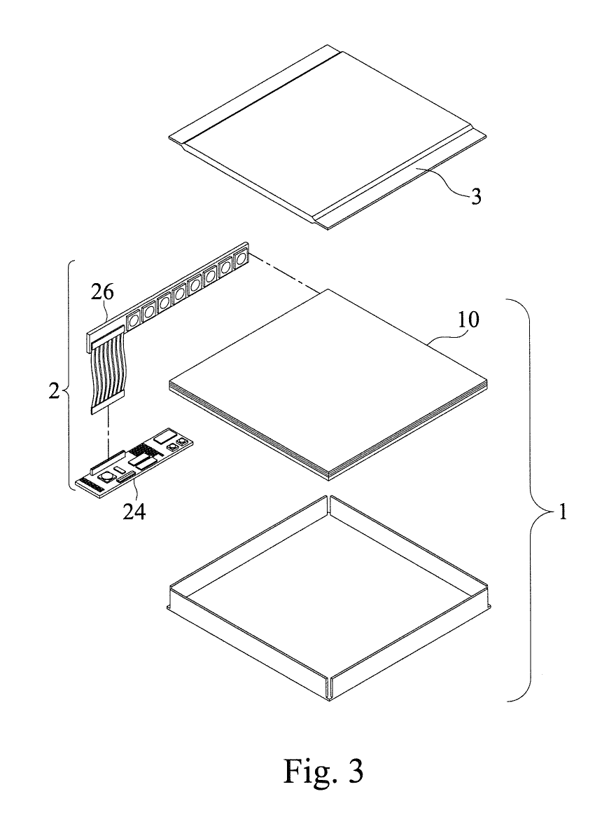

The light bar 26 can be horizontally disposed in the backlight module 1. As shown in FIG. 3 for a schematic diagram (II) of an installation in accordance with a preferred embodiment of the present invention, the light bar 26 is arranged to form a long strip structure corresponding to a side of a light guide plate of the backlight module 1 so that the display backlight structure 2 capable of enhancing color saturation degree and brilliance and white balance is inserted into at least one side of the backlight module 1. Its emitted light is refracted by an optical module 10 of the backlight module 1 to an upper plane of the optical module 10, and white light is uniformly passed by optical films, such as a prism, a diffusion sheet, from the upper plane of the backlight module 1, thereby forming a planar light source.

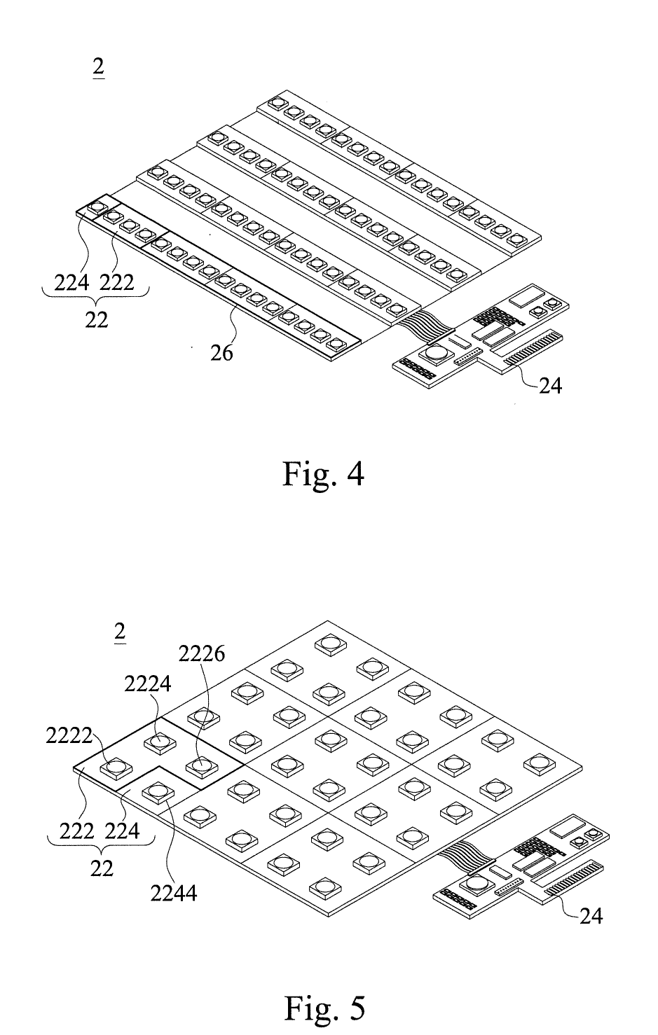

In addition, the light bar 26 can be vertically disposed in the backlight module 1 as shown in FIG. 1 for a schematic diagram (I) of an installation in accordance with a preferred embodiment of the invention. With reference to FIG. 4 and FIG. 1 for a schematic diagram of an assembly in accordance with a preferred embodiment of the invention are depicted. The light bar 26 is arranged in parallel to form a plane structure corresponding to a bottom of the backlight module 1. The display backlight structure 2 capable of enhancing color saturation degree and brilliance and white balance is placed to the bottom of the backlight module 1. Its placing manner can be either a horizontal line direction or a vertical line horizontal relative to the liquid crystal display module 3. Moreover, the light emitted by the display backlight structure 2 capable of enhancing color saturation degree and brilliance and white balance is scattered by the optical module 10 of the backlight module 1 to an upper plane of the optical module 10 and passed by the optical films, such as the prism and the diffusion sheet, from the backlight module 1, thereby providing uniform white light for the liquid crystal display module 3.

With reference to FIG. 5 for a schematic diagram of an assembly in accordance with another preferred embodiment of the present invention is depicted. The color light source unit 222 and the luminance light source unit 224 are disposed to form a 2*2 array structure having the red light LED 2222, the green light LED 2224, the blue light LED 2226 and the white light LED 2224, which are irregularly arranged. Accordingly, the light emitting areas 22 are adjoined to each other to form a matrix structure corresponding to a size of the backlight module 1.

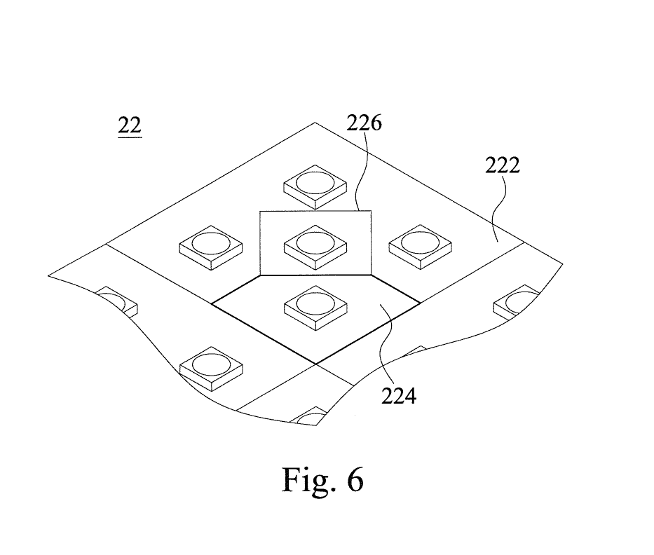

With reference to FIG. 6 for a schematic diagram of reinforcement in accordance with another preferable embodiment of the invention is depicted. The light emitting areas 22 of the 2*2 array structure further comprises a reinforced light source unit 226 that is incorporated with a product demand of high luminance requirement to increase the luminance performance for the display backlight structure 2 capable of enhancing color saturation degree and brilliance and white balance. The reinforced light source unit 226 contains a green light or white light LED that is placed in a central position of the light emitting areas 22 of the 2*2 array structure and that is surrounded by the color light source unit 222 and the luminance light source unit 224. Since the luminance of green light and white light sensed by human eyes is higher at the same power, their optical spectrum slightly influence the optical spectrum feature of the display backlight structure 2 capable of enhancing color saturation degree and brilliance and white balance. The original white balance can be retained by the controller 24. Therefore, the structure can increase the luminance of the light emitting areas 22 without influencing other optical features.

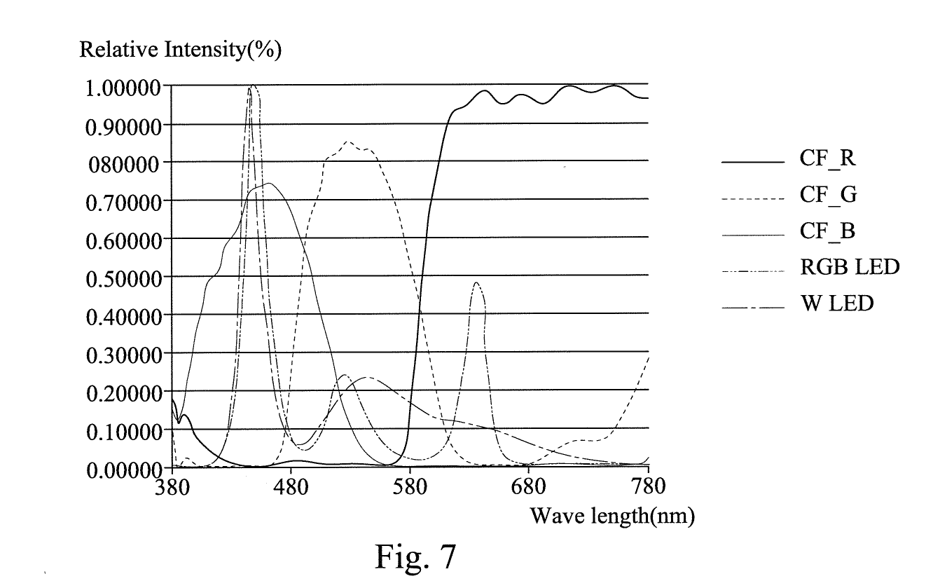

The effects of high color saturation degree, high luminance and optimum white balance can be obtained by the display backlight structure 2 capable of enhancing color saturation degree and brilliance and white balance. With reference to FIG. 7 for a spectrum distribution diagram in accordance with another preferable embodiment of the present invention is depicted. The frequency spectrum of a color filter (CF), the color light source unit 222 and the luminance light source unit 224 used by the present invention is shown. The backlight module 1 is measured to incorporate with the liquid crystal display module 3 having the CF in which NTSC is 68.9%. The following data can be obtained by the optical testing:

| | Transmissivity | NTSC |
|---|---|---|
| Conventional RGB color mixing light source | 30% | 104.12% |
| Display backlight structure capable of | 39% | 104.12% |
| enhancing color saturation degree and | | |
| brilliance and white balance | | |

Higher luminance can be obtained from greater transmissivity. During the experiment demonstration, when the color light source unit 222 and the luminance light source unit 224 are fully turned-on, the luminance of the liquid crystal display module 3 is enhanced. High luminance than a conventional RGB color mixing light source can be obtained although they are gradated. In the performance of NTSC color gamut, the invention can reach the same level as well as the conventional RGB color mixing light source. The conventional RGB color mixing light source is difficulty in precisely regulating white balance to easily cause color deviation. After adding the luminance light source unit 224 of white light, the system can be easily regulated to obtain optimum white balance. In addition, the color light source unit 222 and the luminance light source unit 224 can be turned on/off and gradated to optimize white balance.

The invention combines two white light LED backlight source structures of the conventional RGB light mixing source and the white light LED source and utilizes optical features to allow the invention to have both advantages of high color saturation degree and high luminance. The insufficient color rendering index of the conventional white light LED source and worse luminance performance of the conventional RGB light mixing source can be effectively improved, and the shortcoming of difficult-regulating white balance of the conventional RGB light mixing source can be further improved to achieve benefit so that the optical efficiency of the backlight module can be enhanced to allow displays having well development at high quality.

The display backlight structure capable of enhancing color saturation degree and brilliance and white balance improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A display backlight structure capable of enhancing color saturation degree and brilliance and white balance disposed in a backlight module to provide light source for a liquid crystal display module, the display backlight structure comprising:
a plurality of light emitting areas adjoined to each other and respectively comprising:
a color light source unit having a red light LED, a green light LED and a blue light LED; and
a luminance light source unit having a white light LED; and
a controller electrically connected to the color light source unit and the luminance light source unit to regulate turning-on/off or gradation of the color light source unit and the luminance light source unit.

2. The display backlight structure capable of enhancing color saturation degree and brilliance and white balance as recited in claim 1, wherein the color light source unit and the luminance light source unit are disposed to form at least a 1*4 single bar structure, which is irregularly disposed, having the red light LED, the green light LED, the blue light LED and the white light LED to allow the light emitting areas adjoined to each other to form at least one light bar.

3. The display backlight structure capable of enhancing color saturation degree and brilliance and white balance as recited in claim 2, wherein the light bar is horizontally disposed in the backlight module.

4. The display backlight structure capable of enhancing color saturation degree and brilliance and white balance as recited in claim 2, wherein the light bar is vertically disposed in the backlight module.

5. The display backlight structure capable of enhancing color saturation degree and brilliance and white balance as recited in claim 4, wherein the light bar is arranged and spaced in parallel relative to a horizontal direction of the liquid crystal display module in the backlight module.

6. The display backlight structure capable of enhancing color saturation degree and brilliance and white balance as recited in claim 4, wherein the light bar is arranged and spaced in parallel relative to a vertical direction of the liquid crystal display module in the backlight module.

7. The display backlight structure capable of enhancing color saturation degree and brilliance and white balance as recited in claim 1, wherein the color light source unit and the luminance light source unit are disposed to form a 2*2 array structure, which is irregularly disposed, having the red light LED, the green light LED, the blue light LED and the white light LED to allow the light emitting areas adjoined to each other, thereby forming a matrix structure corresponding to a size of the backlight module.

8. The display backlight structure capable of enhancing color saturation degree and brilliance and white balance as recited in claim 7, wherein each light emitting area further comprises a reinforced light source unit disposed in a central position of the 2*2 array structure.

9. The display backlight structure capable of enhancing color saturation degree and brilliance and white balance as recited in claim 8, wherein the reinforced light source unit has a green light LED.

10. The display backlight structure capable of enhancing color saturation degree and brilliance and white balance as recited in claim 8, wherein the reinforced light source unit has a white light LED.
